(19) United States
(12) Patent Application Publication
(10) Pub. No.: US 2026/0084253 A1
(43) Pub. Date: Mar. 26, 2026

(54) CROWN MOLDING CUTTING JIG

(71) Applicant: Samuel D. Henry, Elgin, IL (US)

(72) Inventor: Samuel D. Henry, Elgin, IL (US)

(73) Assignee: BAM IP Holding LLC, Saint Charles, IL (US)

(21) Appl. No.: 18/896,262

(22) Filed: Sep. 25, 2024

(51) Int. Cl. B23Q 3/00; B23D 47/04

(52) U.S. Cl. CPC B23Q 3/005; B23D 47/04

(57) ABSTRACT

A jig for supporting crown molding to cut the crown molding using a miter saw is provided. The jig can support crown molding in the traditional reverse orientation or a cut it as you hang it orientation. The jig can be adjusted for use with different miter saws. Further, the jig can be adjusted for use with different size crown molding or crown molding having different angles.

### FIELD OF THE INVENTION

This invention generally relates to jigs for holding workpieces to be cut and more particularly to jigs for holding crown molding to be cut.

### BACKGROUND OF THE INVENTION

Crown molding typically includes a mounting surface that abuts a wall and a mounting surface that abuts the ceiling when installed at the junction of a wall with a ceiling. While these surfaces typically extend perpendicular to one another, they are often not intersecting or close together. As such, it can be difficult to position the crown molding to cut it. Further complicating the situation is that the cuts are often on an angle so that two pieces that extend perpendicular to one another can butted up against one another at a corner of the room.

Typically, crown molding requires the woodworker to position in the workpiece in a non-logical position that is typically a reversed position and not in a position that when viewed corresponds to the way that the crown molding will be mounted relative to the wall and/or ceiling.

Some jigs have been created to help inexperienced woodworkers to support the workpiece in an orientation similar to how it will be mounted to the wall so that they can better visualize the cut while the workpiece is situated relative the saw to better avoid making an incorrect cut.

However, prior jigs are complicated, cannot work with different shaped/configured pieces of crown molding, and/or do not allow a more experienced wood worker to support the workpiece in the typical reverse orientation.

Further, prior jigs were not able to be flexibly mounted to the saw, such as to a vertical fence of the saw and/or be used with a large number of different saws due to varying hole patterns within the vertical fence of the saw.

Examples herein provide new and improved jigs for supporting workpieces and particularly workpieces of crown molding relative to a saw for cutting the workpiece.

### BRIEF SUMMARY OF THE INVENTION

Therefore, the application provides new and improved jigs and components for jigs for assisting users in supporting workpieces relative to a miter saw and particularly crown molding to be cut by a miter saw.

In one example, a jig for supporting a piece of crown molding to be cut by a miter saw is provided. The miter saw may have a vertical fence having a first mounting aperture through the vertical fence. The jig includes a workpiece support fence having a first wall having a first workpiece support surface. The jig may optionally have a second wall extending forward from the first wall, which may optionally provide a second workpiece support surface. The jig includes a workpiece support fence mounting arrangement. The mounting arrangement includes a back plate configured to attach the workpiece support fence to the miter saw. The back plate has a first horizontal slot and a first vertical slot. The back plate having a front side facing the workpiece support fence in an assembled state and an opposite rear side facing away from the workpiece support fence in the assembled state. The rear side faces the vertical fence when mounted to the miter saw. A first connector attachable to the back plate within the first vertical slot secures the workpiece support fence to the back plate for vertically adjustably positioning the workpiece support fence relative to the back plate. A second connector extends rearward from the rear side of the back plate for extending through the first mounting aperture in the vertical fence. The second connector is adjustably positionable within the first horizontal slot to allow for adjusting the horizontal position of the back plate relative to the vertical fence of the miter saw when mounted thereto.

In one example, the first connector is a first T-bolt having a shaft portion connected to a head portion receivable in the first vertical slot. The first vertical slot is configured to prevent the head portion of the first T-bolt from freely rotating relative to the back plate when received in the first vertical slot. The second connector is a second T-bolt having a shaft portion connected to a head portion receivable in the first horizontal slot. The first horizontal slot is configured to prevent the head portion of the second T-bolt from freely rotating relative to the back plate when received in the first horizontal slot.

In one example, the back plate includes a back plate body that defines the first horizontal slot. The back plate includes a back plate vertical bar attached to the back plate body. The back plate vertical bar defines the first vertical slot.

In one example, the first connector includes a first knob threadedly attached to shaft of the first T-bolt. The first knob is located in a first recess in the first workpiece support surface of the first wall of the workpiece support fence such that the first knob does not protrude forward beyond the first workpiece support surface.

In one example, a workpiece support fence mounting arrangement for mounting a workpiece support fence to a miter saw is provided. The workpiece support fence may have, for reference, a first wall having a first workpiece support surface and an optional second wall extending forward from the first wall having a second surface. The miter saw may have a vertical fence having a first mounting aperture through the vertical fence. The workpiece support fence mounting arrangement includes a back plate and first and second connectors. The back plate is configured to attach the workpiece support fence to the miter saw. The back plate has a first horizontal slot and a first vertical slot. The back plate has a front side facing the workpiece support fence in an assembled state and an opposite rear side facing away from the workpiece support fence in the assembled state. The rear side faces the vertical fence when mounted to the miter saw. The first connector is attachable to the back plate within the first vertical slot configured for securing the workpiece support fence to the back plate for vertically adjustably positioning the workpiece support fence relative to the back plate. The second connector extends rearward from the rear side of the back plate for extending through the first mounting aperture in the vertical fence. The second connector is adjustably positionable within the first horizontal slot to allow for adjusting the horizontal position of the back plate relative to the vertical fence of the miter saw when mounted thereto.

In an example, a jig for supporting a piece of crown molding to be cut by a miter saw is provided. The miter saw may have a vertical fence having a first mounting aperture through the vertical fence. The jig includes a workpiece support fence portion and a first workpiece support block assembly. The workpiece support fence portion has a first wall having a first workpiece support surface and a second wall extending forward from the first wall. The first workpiece support block assembly is removably attachable to the second wall. The workpiece support block assembly is selectively configurable relative to the workpiece support fence portion in a first and a second configuration. In the first configuration, a third workpiece support surface of the workpiece support block assembly extends at a first angle relative to the first workpiece support surface. The first angle is such that the third workpiece support surface extends in a non-perpendicular and non-parallel orientation relative to the first workpiece support surface. In a second configuration, a fourth workpiece support surface of the workpiece support block assembly extends at a second angle relative to the first workpiece support surface. The second angle is non-perpendicular and non-parallel to the first workpiece support surface. The second angle is different than the first angle.

In one example, the first workpiece support block assembly includes a first body and a second body. The first body is movably attachable to the second wall of the workpiece support fence portion. The first body provides the third workpiece support surface when in the first configuration. The second body is removably attachable to the first body. The second body is attached to the first body in the second configuration. The second body provides the fourth workpiece support surface in the second configuration.

In one example, the second body attaches to the third workpiece support surface of the first body when in the second configuration.

In one example, in the first configuration, the third workpiece support surface faces the first workpiece support surface. In the second configuration, the fourth workpiece support surface faces the first workpiece support surface.

In one example, the second body is not used in the first configuration.

In one example, the third workpiece support surface and second body have a cooperating slot and tab connection for selectively attaching the first body to the second body in the second configuration.

In one example, the first workpiece support block assembly is adjustably positionable relative to the first wall such that a position of the workpiece support block relative to the first wall is adjustable along an adjustment axis being generally perpendicular to the first workpiece support surface. A connector selectively secures the first body to the second wall. The second wall has a slot, optionally in the second workpiece support surface, extending along the adjustment axis. The connector has a head portion received in the slot to secure the first workpiece support block to the second wall.

In one example, a bottom side of the first body and the second workpiece support surface have cooperating slots and ribs for aligning the first body relative to the workpiece support fence portion and permitting sliding of the first body relative to the workpiece support fence portion along an adjustment axis being orthogonal to the first workpiece support surface.

In one example, a second workpiece support block has a fifth workpiece support surface. When the second workpiece support block is attached to the second wall, the fifth workpiece support surface extends at a third angle relative to the first workpiece support surface. The third angle being different than the first and second angles.

In one example, the third angle is such that the fifth workpiece support surface is more parallel to the first workpiece support surface than the third or fourth workpiece support surfaces.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a miter saw having a crown molding cutting jig in two separate configurations for supporting crown molding in a traditional reverse orientation as well as for supporting crown molding in cut it as you hang it orientation;

FIG. 2 is an exploded perspective illustration of the crown molding cutting jig;

FIG. 3 is a partial exploded side view illustration of the crown molding cutting jig showing multiple components of a workpiece support block that can be configured to support different configurations of crown molding in a cut it as you hang it orientation;

FIG. 4 is a perspective illustration of a portion of a workpiece support block of the crown molding cutting jig showing multiple components of the system that can be used for supporting different configurations of crown molding;

FIG. 5 is a side view illustration of a portion of the crown molding cutting jig supporting a piece of crown molding in a cut it as you hang it orientation;

FIG. 6 is the side view illustration of FIG. 5 with the crown molding removed from the jig;

FIG. 7 is a perspective illustration of a portion of the workpiece support fence of the crown molding cutting jig;

FIG. 8 is a side exploded view of an alternative workpiece support block for use in the crown molding cutting jig for supporting the crown molding in the traditional reverse orientation;

FIG. 9 is a rear perspective view of the workpiece support block of FIG. 8;

FIG. 10 is a side view illustration of the crown molding cutting jig in a reverse orientation configuration and supporting a piece of crown molding;

FIG. 11 is a perspective illustration of a mounting arrangement used to mount a fence of the crown molding jig to a miter saw;

FIG. 12 is an exploded illustration of the mounting arrangement; and

FIG. 13 is a partial exploded illustration of the mounting arrangement positioned relative to a miter saw.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

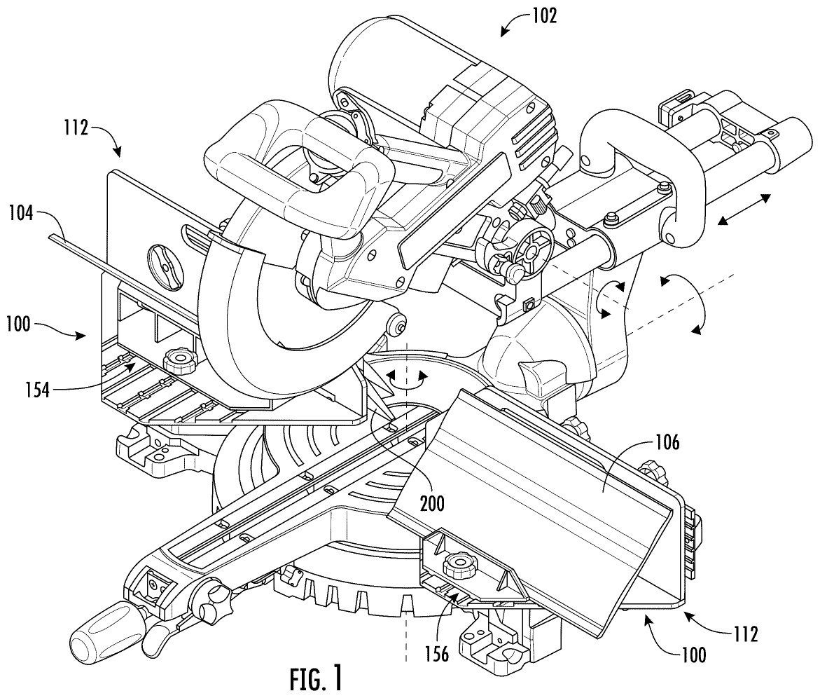

FIG. 1 illustrates an implementation of a crown molding cutting jig 100 in use with a miter saw 102. The miter saw 102 in FIG. 1 is a compound sliding miter saw which allows for may different adjustments in cutting location, angle, and depth. However, the jig 100 can be used with other miter saws as will be appreciated.

The crown molding cutting jig 100 is used to support workpieces such as crown molding 104, 106 in FIG. 1 in the miter saw 102 as the workpiece is to be cut. The crown molding cutting jig 100 finds particular usefulness for supporting crown molding due to the shape and lack of closely adjacent square sides of crown molding.

As noted, crown molding was traditionally cut in a reverse orientation due to the orientation of the orthogonal mounting surfaces of crown molding. More recently, jigs have been created to allow a user to position crown molding within the miter saw so that the crown molding is positioned in an orientation as it will look when installed, often referred to as a cut it like you hang it orientation.

As will be described configurations of the crown molding cutting jig 100 can be used to support the crown molding to be cut in either the traditional reverse orientation (see e.g. crown molding 106) or the cut it like you hang it orientation (see e.g. crown molding 104). Further yet, configurations of the crown molding cutting jig 100 may be used to support different types of crown molding such as 38°, 45°, or 52° crown molding.

In FIG. 1, two workpieces 104, 106 are illustrated along with two different crown molding cutting jig configurations of the crown molding cutting jig 100. Typically, the crown molding cutting jig 100 will only be in one configuration at a time such that it will be used to either support the workpiece in the cut it like you hang it orientation (e.g. workpiece 104) or the traditional reverse orientation (e.g. workpiece 106). However, both orientations are shown in FIG. 1 simply for illustrative purposes.

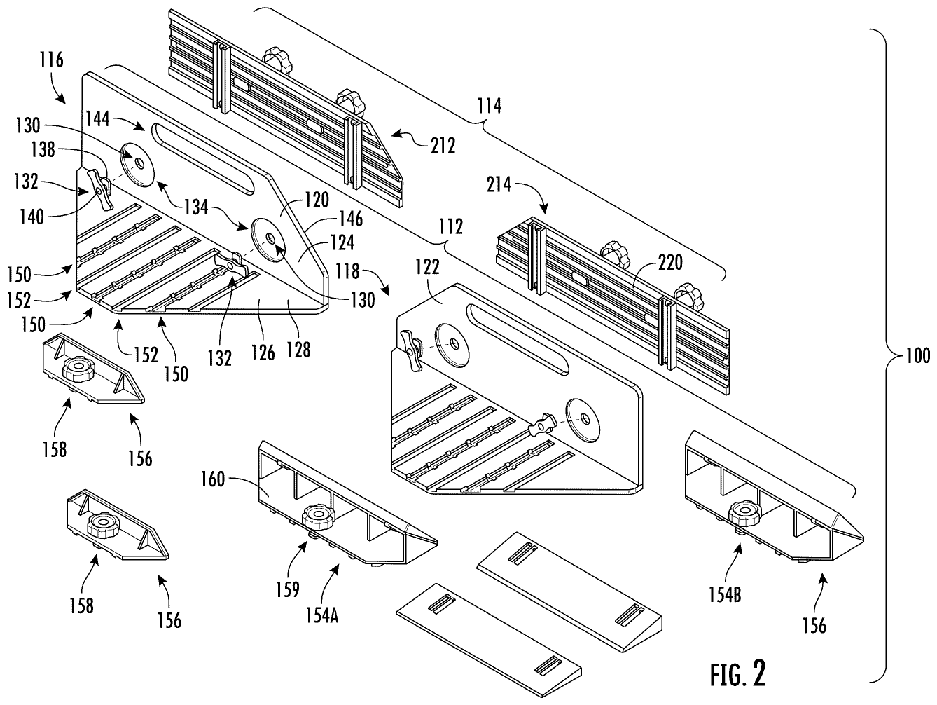

FIG. 2 illustrates the crown molding cutting jig 100 removed from miter saw 102 and with the components in partially exploded configuration. The example of the crown molding cutting jig 100 is a preferred system of components and other examples may or may not have all of the components illustrated in FIG. 2.

The crown molding cutting jig 100 in the illustrated example generally includes a workpiece support fence 112 and a workpiece support fence mounting arrangement 114. In some examples only a workpiece support fence 112 is provided. Also, the workpiece support fence mounting arrangement 114 may find usefulness independent of the workpiece support fence 112 such as being used with other workpiece support fences.

The workpiece support fence 112 is generally used to support the workpieces during cutting operations while the workpiece support fence mounting arrangement 114 is used to secure the workpiece support fence 112 to the miter saw 102.

The workpiece support fence 112 is a system of components. In this example, the workpiece support fence 112 includes first and second fence portions 116, 118. First fence portion 116 is generally a left side portion and second fence portion 118 is a right side portion. In some examples, only a single first or second fence portion 116, 118 and not both may be provided. Further, while in this example, the first and second fence portions 116, 118 are configured slightly different (note the tapered inner corners of the upright rear walls 120, 122), other examples may have first and second fence portions that are identical to one another.

The first and second fence portions 116, 118 are generally similar to one another and thus only first fence portion 116 will be described in more detail with the details generally applicable to second fence portion 118.

First fence portion 116 includes first wall 120 which is typically vertically oriented when operably mounted to the miter saw 102. The first wall 120 includes a first support surface 124, which will typically support a surface of a workpiece during cutting operations. A second wall 126 extends forward of the first wall 120 and first support surface 124. The second wall 126 includes a second support surface 128. The first and second walls 120, 126 as well as corresponding first and second support surfaces 124, 128 are preferably orthogonal to one another.

The first wall 120 includes at least one (two in this embodiment) apertures 130 for receiving corresponding connectors 132 for operably attaching the first fence portion 116 to the workpiece support fence mounting arrangement 114. Optionally, the apertures 130 are formed through recessed regions 134 formed in the first support surface 124 such that knobs 136 of connectors 132 may be recessed rearward of first support surface 124.

In this example, connectors 132 include T-bolts having head portions 138 and threaded shafts 140 that cooperate with knobs 136. The threaded engagement of knobs 136 with the T-bolts allows for selectively tightening and releasing the connectors 132.

In this example, optional handle regions 144 are provided in the first wall 120. The handle regions 144 in this example are large apertures that extend entirely through the first wall 120.

In this example, the first wall 120 has a tapered edge 146. The tapered edge allows for more clearance when the miter saw is oriented at an angle. The tapered edge 146 would typically be located closest to the saw blade when attached to the miter saw 102.

The second wall 126 includes locating slots 150, 152 formed in the second support surface 128. Slots 150 are generally T-slots used for securing workpiece support blocks 154, 156 by way of connectors 158, 159. Connectors 158, 159 include T-bolts that have head portions and threaded shafts that cooperate with knobs for tightening and loosening the connectors relative to the second wall 126.

The T-slot configuration of slots 150 have one or more over hangs that capture the head portions of connectors 158, 159 to secure the head portions therein.

Slots 152 do not include over hangs and are generally used for keeping the workpiece support blocks 154, 156 square relative to the first wall 120, when mounted to the first fence portion 116.

In this example, the system includes two different types of workpiece support blocks 154, 156. The workpiece support blocks 154, 156 support various portions of the workpiece during cutting operations depending on which orientation the workpiece is being supported during cutting (see e.g. workpieces 104, 106 in FIG. 1).

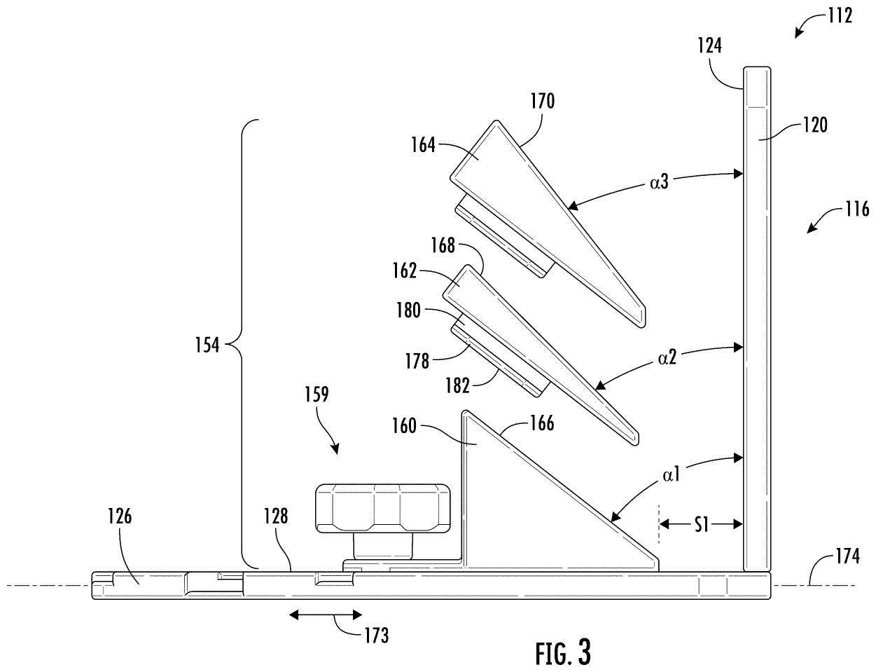

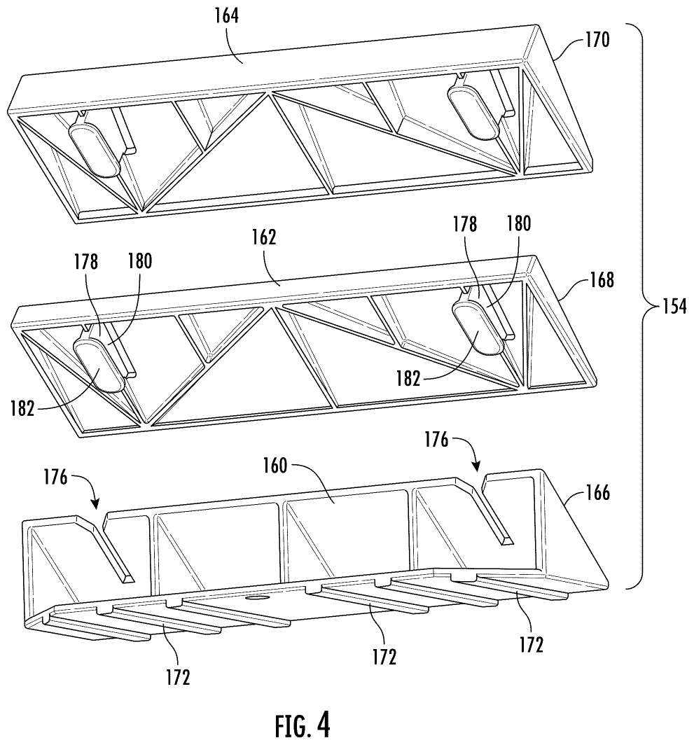

With additional reference to FIGS. 3 and 4, the first workpiece support block 154 is a reconfigurable workpiece support block and is used for cut it as it hangs cutting operations. The workpiece support block 154 is reconfigurable between different configurations for supporting crown molding having different angle configurations. In this example, the workpiece support block 154 is reconfigurable between three configurations for supporting 38°, 45°, or 52° crown molding in the cut it as it hangs orientation.

In particular, the first workpiece support block 154 is reconfigurable to provide a workpiece support surface at different non-parallel, non-perpendicular angles relative to the first workpiece support surface 124 of the first wall 120.

In general, the first workpiece support block 154 includes a first body 160, a second body 162 and a third body 164. The first body 160 provides a first support surface 166 for use with 52° crown molding. The second body 162 provides a second support surface 168 for use with 45° crown molding. The third body 164 provides a third support surface 170 for use with 38° crown molding.

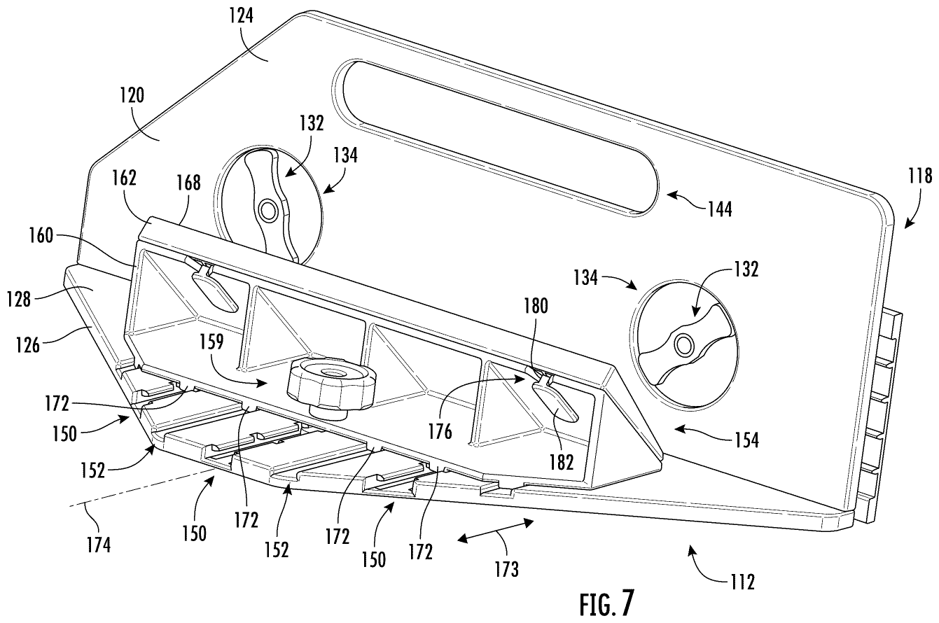

The first body 160 is configured to be operably releasably secured to the second wall 126 of the fence portion 116 by way of connector 159. Additionally, the first body 160 includes ribbing 172 (see e.g. FIGS. 4 and 7) that cooperates with corresponding ones of slots 150, 152 (see e.g. FIGS. 2 and 7) so as to properly align the first body 160 relative to the fence portion 116, and particularly, first wall 120 thereof.

Preferably, the ribbing 172 and slots 150, 152 cooperate with one another such that the first body 160 is slidable relative to second wall 118 toward or away from first support surface 124 (illustrated by arrow 173) when connector 159 is securing the first body 160 to second wall 126 in a loosened state.

When positioned in a desired spacing S1 from first support surface 124, the user may tighten connector 159 to fix the position of the first body along an adjustment axis 174 that is perpendicular to first support surface 124. Spacing S1 can be adjusted so as to accommodate different sized and shaped crown molding

In this example, connector 159 clamps a bottom of the first body 160 against a top of second wall 126.

In this example, support surface 166 makes a first angle α1 relative to support surface 124. First angle α1 corresponds to supporting a piece of 52° crown molding.

To accommodate 45° crown molding, the second body 162 is attached to the first body 160. In this example, the second body 162 is mounted on top of support surface 166. The second body 162 is mounted to first body 160 by way of interlocking slots 176 and tabs 178. Here, the slots are provided by the first body 160 and the tabs 178 are provided by the second body 162 (see e.g. FIG. 4).

The tabs 178 have legs 180 that offset heads 182. The heads 182 are sized larger than the width of the slots 176 to secure the two components to one another. In this example, the legs 180 will extend through the slots 176 and can be slid therein to properly position the second body 162 relative to the first body 160. Other tabs and slot arrangements are contemplated as well as other ways to secure the two components.

When the second body 162 is attached to the first body 160, the second support surface 168 forms a second angle α2 that corresponds to supporting a piece of 45° crown molding.

Once again, the spacing S1 can be adjusted to accommodate different sized and shaped 45° crown molding.

The third body 164 is substantially similar to second body 162. However, the third support surface 170 makes a third angle α3 for accommodating a piece of 38° crown molding.

Thus, the first workpiece support block 154 is reconfigurable, in this example, by removing or attaching various ones of the second and third bodies 162, 164 from or to the first body 160.

While the first, second and third support surfaces 166, 168, 170 are illustrated by being provided by different members, it is contemplated that in some examples, the different support surfaces could be provided by a single body and the body would be reoriented relative to the fence portion 116 to provide the different angles required for supporting different shaped, sized and configured crown molding.

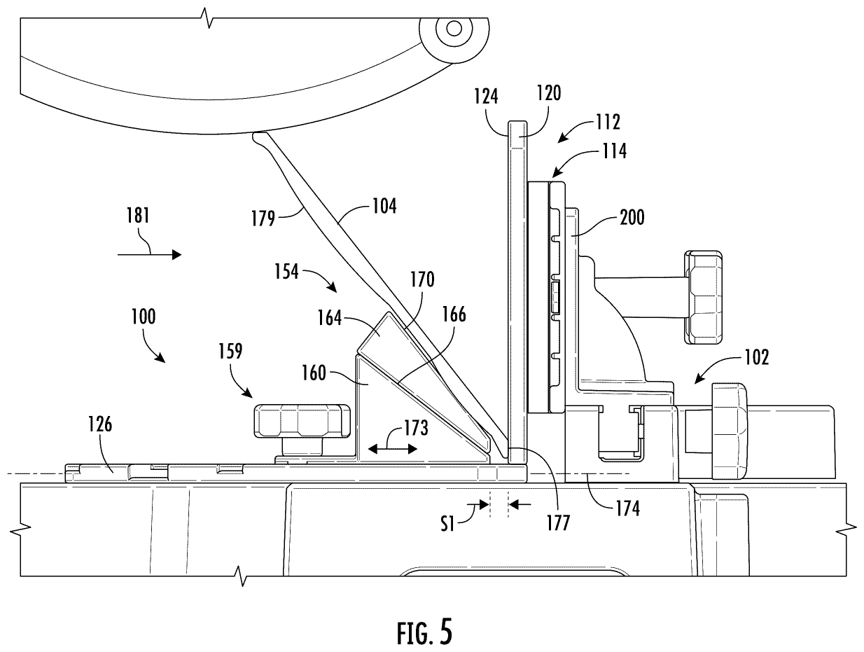

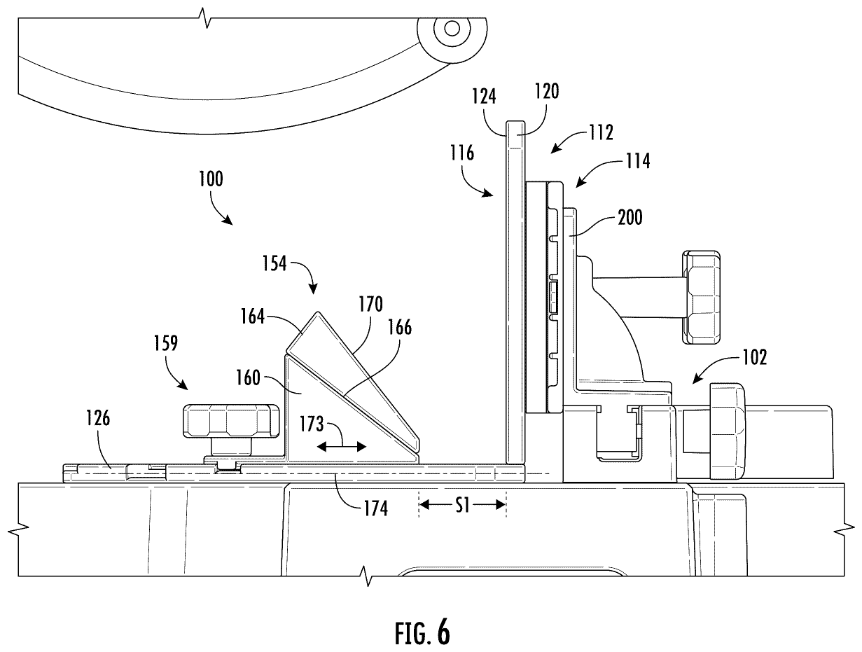

FIGS. 5 and 6 illustrate the first workpiece support block 154 in use supporting a piece of 38° crown molding 104. In this situation, the abutment surface 177 of the crown molding 104 that would typically abut a vertical wall when the crown molding is installed in a room is supported against first support surface 124 of first wall 120. Decorative face 179 of the crown molding 104 rests against third support surface 170. In this orientation, the crown molding 104 is in the cut it as it hangs orientation as the operator would view the crown molding 104 such as if it were mounted in the room, such as illustrated by arrow 181.

For 45° crown molding, a different configuration would be used. In particular, third body 164 would be replaced with second body 162 to support the corresponding piece of crown molding. For 52° crown molding a further configuration would be used. In particular, only first body 160 would be used to support the corresponding piece of crown molding.

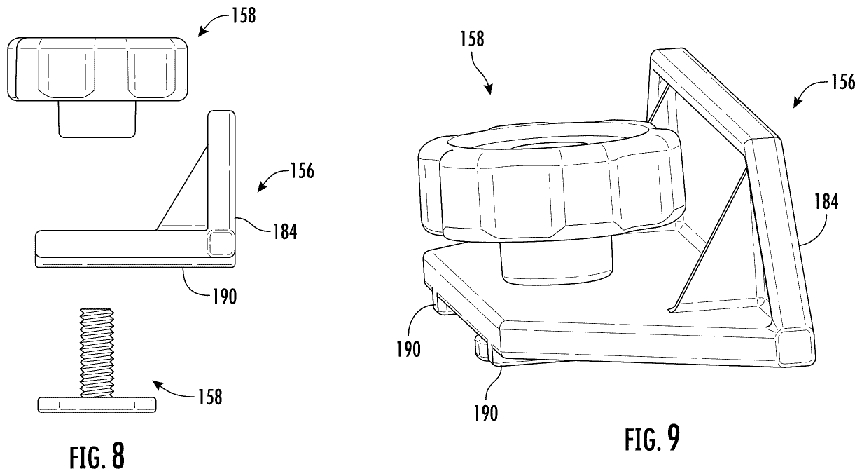

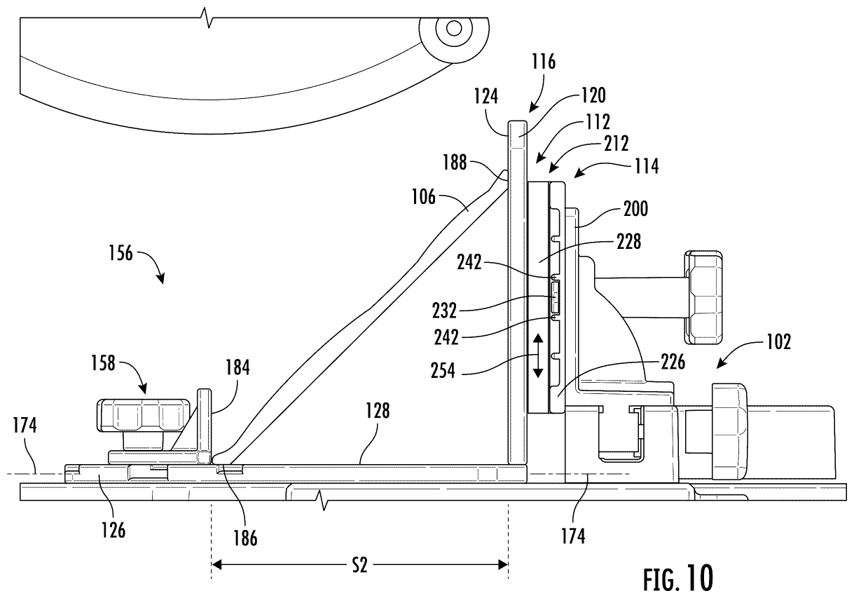

With reference to FIGS. 8-10, the system of the illustrated example includes second workpiece support block 156. The second workpiece support block 156 is configured to assist in supporting a workpiece in the traditional reverse orientation as illustrated in FIG. 10.

Here, the workpiece support block 156 provides a fourth workpiece support surface 184 that is generally parallel to support surface 124 of first wall 120. Again, the workpiece support block 156 is removably and adjustably attachable to second wall 126 using connector 158 and cooperating ribbing 190 and slots 150, 152 in a similar fashion as first workpiece support block 154.

When supporting the workpiece 106 in this orientation, the two surfaces 186, 188 of the workpiece that would be positioned against the ceiling and walls of the room when the crown molding is installed are positioned against the support surfaces 124, 128 of fence portion 116.

Again, spacing S2 is adjustable to accommodate different sized and shaped crown molding 106.

It is contemplated that the fourth support surface 184 could be provided by one of the first, second or third bodies 160, 162, 164 outlined above to avoid the need for an additional component. However, for simplicity of use and understanding by the operator, an entirely separate component for operating the jig 100 in the reverse orientation can be useful.

In addition to the different ways for supporting crown molding, the instant system provides for improved attachment to the miter saw 102 by way of workpiece support fence mounting arrangement 114.

The illustrated example attaches the workpiece support fence 112 to the vertical fence 200 (see e.g. FIGS. 5, 6 and 10) of the miter saw 102.

The workpiece support fence mounting arrangement 114 provides mounting flexibility for attaching the workpiece support fence 112 to differently configured miter saws 102 as well as adjusting the position of the workpiece support fence 112 relative to the miter saw 102 and particularly the blade thereof.

The workpiece support fence mounting arrangement 114 includes first and mounting arrangement portions 210, 212 for mounting corresponding ones of the first and second fence portions 116, 118. Here, first and second mounting arrangement portions 210, 212 are substantially similar to one another except for the tapered edge thereof similar to fence portions 116, 118.

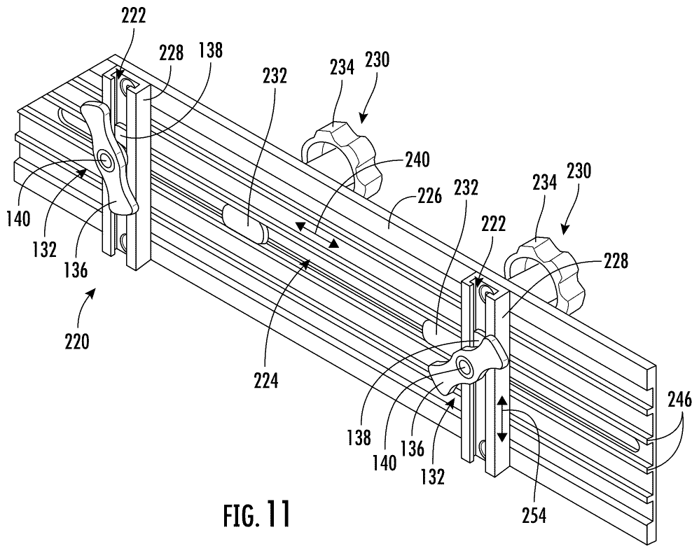

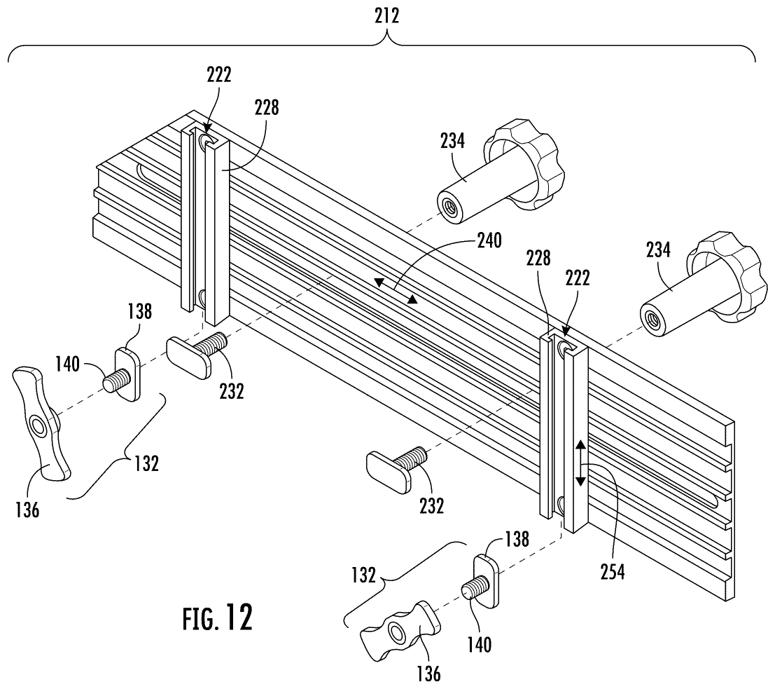

With additional reference to FIG. 11-13, mounting portion 212 will be described.

Mounting portion 212 includes a back plate 220 that includes first and second vertical slots 222 and a horizontal slot 224. While illustrated as an assembly of parts, back plate 220 in other arrangements could be a single one piece constructions.

Here, the back plate 220 includes back plate body 226 that defines horizontal slot 224 and first and second vertical bars 228 that define first and second vertical slots 222. In this example, the vertical bars 228 are attached to the back plate body 226 by screws but other attachment options are contemplated such as bolts, welding, rivets, etc.

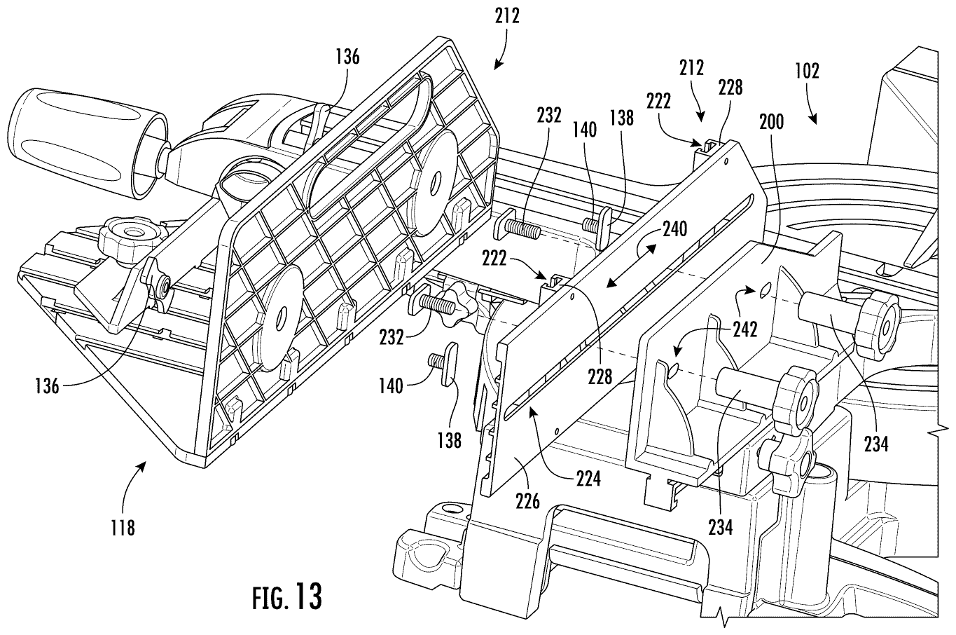

Connectors 230 are used to releasably and adjustably attach the back plate 220 by way of back plate body 226 to the vertical fence 200 of the miter saw 102 (see e.g. FIGS. 10 and 13). Connectors 230, in this example, include a T-bolt 232 and knob 234.

The connectors 230 and particularly T-bolts 232 are adjustably positionable, and preferably slidable, within slot 224 to adjust the position of mounting portion 212 horizontally relative to the miter saw 102 and particularly vertical fence 200.

This adjustability between the connectors 230 and back plate body 226 also allows for accommodating different hole patterns in vertical fence 200 of the miter saw 102.

In particular, the threaded shaft portion of T-bolts 232 extend through apertures 242 in vertical fence 200 of the miter saw 102. Again, the slot 224 allows for accommodating different lateral spacing between apertures 242 in the vertical fence 200.

A front side of the back plate body 226 includes ribs 246. The ribs 246 above and below slot 224 engage the head portion of T-bolt 232 to prevent free rotation thereof when tightening knobs 234.

An opposite rear side of the back plate body 226 faces the vertical fence 200 and, in some examples, is pressed thereagainst in an assembled state (see e.g. FIG. 10).

In addition to the horizontal adjustability, the mounting arrangement portion 212 provides vertical adjustability. In particular, connectors 132 releasably and adjustably secure the corresponding fence portion 116, 118 to vertical bars 228.

In particular, head 138 portions of T-bolts of connectors 132 are slidably and removably receivable in slots 222, illustrated by vertical arrow 254. With knobs 136 in a loosened state, the T-bolts can slide within slots 222.

In this example, slots 222 are T-slots and have undercut regions to secure the head portions 138 of T-bolts slidably therein.

This vertical adjustability allows for vertically adjusting the position of the fence portion 116, 118 relative to the vertical fence 200 of miter saw 102.

Connectors 132, when tightened, clamp the first wall 120 of the fence portion 116, 118 against the vertical bars 228 to fix the vertical position of the fence portion 116, 118 relative to the miter saw 102.

While two connectors 132, 230 are used in the illustrated example a single connector could be provided or more connectors could be provided.

As noted previously, the illustrated example uses two fence portions 116, 118 and corresponding two mounting portions 212, 214. However, other systems may only have a single one of the fence portions 116, 118 and only a single corresponding mounting portion 212, 214.

Further, while T-bolt connectors are used in most instances, other arrangements could use other connectors. Further, the arrangement could have discrete positions for the various workpiece support blocks as well as discrete positions for the adjustments provided by the workpiece support fence mounting arrangement 114.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A jig for supporting a piece of crown molding to be cut by a miter saw having a vertical fence having a first mounting aperture through the vertical fence, the jig comprising:
a workpiece support fence having a first wall having a first workpiece support surface and a second wall extending forward from the first wall;
a workpiece support fence mounting arrangement comprising:
a back plate configured to attach the workpiece support fence to the miter saw, the back plate having a first horizontal slot and a first vertical slot, the back plate having a front side facing the workpiece support fence in an assembled state and an opposite rear side facing away from the workpiece support fence in the assembled state, the rear side facing the vertical fence when mounted to the miter saw;
a first connector attachable to the back plate within the first vertical slot securing the workpiece support fence to the back plate for vertically adjustably positioning the workpiece support fence relative to the back plate;
a second connector extending rearward from the rear side of the back plate for extending through the first mounting aperture in the vertical fence, the second connector adjustably positionable within the first horizontal slot to allow for adjusting the horizontal position of the back plate relative to the vertical fence of the miter saw when mounted thereto.

2. The jig of claim 1, wherein:
the first connector is a first T-bolt having a shaft portion connected to a head portion receivable in the first vertical slot, the first vertical slot configured to prevent the head portion of the first T-bolt from freely rotating relative to the back plate when received in the first vertical slot; and
the second connector is a second T-bolt having a shaft portion connected to a head portion receivable in the first horizontal slot, the first horizontal slot configured to prevent the head portion of the second T-bolt from freely rotating relative to the back plate when received in the first horizontal slot.

3. The jig of claim 2, wherein the back plate includes:
a back plate body that defines the first horizontal slot; and
a back plate vertical bar attached to the back plate body, the back plate vertical bar defining the first vertical slot.

4. The jig of claim 2, wherein:
the first connector includes a first knob threadedly attached to shaft of the first T-bolt, the first knob being located in a first recess in the first workpiece support surface of the first wall of the workpiece support fence such that the first knob does not protrude forward beyond the first workpiece support surface.

5. A workpiece support fence mounting arrangement for mounting a workpiece support fence to a miter saw, the workpiece support fence having a first wall having a first workpiece support surface and a second wall extending forward from the first wall, the miter saw having a vertical fence having a first mounting aperture through the vertical fence, the workpiece support fence mounting arrangement comprising:
a back plate configured to attach the workpiece support fence to the miter saw, the back plate having a first horizontal slot and a first vertical slot, the back plate having a front side facing the workpiece support fence in an assembled state and an opposite rear side facing away from the workpiece support fence in the assembled state, the rear side facing the vertical fence when mounted to the miter saw;
a first connector attachable to the back plate within the first vertical slot configured for securing the workpiece support fence to the back plate for vertically adjustably positioning the workpiece support fence relative to the back plate;
a second connector extending rearward from the rear side of the back plate for extending through the first mounting aperture in the vertical fence, the second connector adjustably positionable within the first horizontal slot to allow for adjusting the horizontal position of the back plate relative to the vertical fence of the miter saw when mounted thereto.

6. A jig for supporting a piece of crown molding to be cut by a miter saw having a vertical fence having a first mounting aperture through the vertical fence, the jig comprising:
a workpiece support fence portion having a first wall having a first workpiece support surface and a second wall extending forward from the first wall;
a first workpiece support block assembly removably attachable to the second wall, the workpiece support block assembly configurable relative to the workpiece support fence portion to selectively provide:
in a first configuration, a third workpiece support surface that extends at a first angle relative to the first workpiece support surface, the first angle is non-perpendicular and non-parallel orientation relative to the first workpiece support surface; and
in a second configuration, a fourth workpiece support surface that extends at a second angle relative to the first workpiece support surface, the second angle is non-perpendicular and non-parallel relative to the first workpiece support surface, the second angle is different than the first angle.

7. The jig of claim 6, wherein:
the first workpiece support block assembly includes:
a first body movably attachable to the second wall of the workpiece support fence portion, the first body providing the third workpiece support surface when in the first configuration; and
a second body removably attachable to the first body, the second body attached to the first body in the second configuration, the second body providing the fourth workpiece support surface in the second configuration.

8. The jig of claim 7, wherein the second body attaches to the third workpiece support surface of the first body when in the second configuration.

9. The jig of claim 6, wherein:
in the first configuration, the third workpiece support surface faces the first workpiece support surface;
in the second configuration, the fourth workpiece support surface faces the first workpiece support surface.

10. The jig of claim 7, wherein the third workpiece support surface and second body have a cooperating slot and tab connection for selectively attaching the first body to the second body in the second configuration.

11. The jig of claim 7, wherein:
the first workpiece support block assembly is adjustably positionable relative to the first wall such that a position of the workpiece support block relative to the first wall is adjustable along an adjustment axis being generally perpendicular to the first workpiece support surface;
further including a connector for selectively securing the first body to the second wall, the second wall having a slot extending along the adjustment axis, the connector having a head portion received in the slot to secure the first workpiece support block to the second wall.

12. The jig of claim 7, wherein a bottom side of the first body and the second workpiece support surface have cooperating slots and ribs for aligning the first body relative to the workpiece support fence portion and permitting sliding of the first body relative to the workpiece support fence portion along an adjustment axis being orthogonal to the first workpiece support surface.

13. The jig of claim 6, further comprising a second workpiece support block having a fifth workpiece support surface, when the second workpiece support block is attached to the second wall, the fifth workpiece support surface extends at a third angle relative to the first workpiece support surface, the third angle being different than the first and second angles.

14. The jig of claim 13, wherein the third angle is such that the fifth workpiece support surface is more parallel to the first workpiece support surface than the third or fourth workpiece support surfaces when assembled.

15. The jig of claim 1, wherein the second wall of the workpiece support fence provides a second workpiece support surface, the second workpiece support surface being orthogonal to the first workpiece support surface.
